(19) United States
(12) Patent Application Publication
(10) Pub. No.: US 2008/0000284 A1
(43) Pub. Date: Jan. 3, 2008

(54) Systems and methods for centrifuge sample holders

(75) Inventors: Thomas M. Laue, Lee, NH (US); J. Brett Austin, South Berwick, ME (US)

Correspondence Address: ROPES & GRAY LLP;PATENT DOCKETING 39/41, ONE INTERNATIONAL PLACE, BOSTON, MA, 02110-2624, US

(73) Assignee: University of New Hampshire

(21) Appl. No.: 11/479,673

(22) Filed: Jun. 30, 2006

(51) Int. Cl. B04B 1/00; B01L 3/00; G01M 19/00

(52) U.S. Cl. 73/1.87; 73/864.91; 73/865.3

(57) ABSTRACT

The systems and methods of the invention provide for sample holders for centrifuges that include a channel structure having a sample channel and an overflow channel. The sample channel and the overflow channel are configured such that any excess sample flows into the overflow channel thereby maintaining a constant sample level in the sample channel. In other aspects, the invention provides for centrifuges comprising sample holders having a plurality of channel structures. In still other aspects, the invention provides for methods of using the sample holder and methods for detecting species in a sample using luminescence based measurement techniques.

### BACKGROUND

The analytical ultracentrifuge is considered to be amongst the most versatile, rigorous and accurate means for determining the molecular weight and hydrodynamic and thermodynamic properties of a protein or other macromolecules. As a result, the analytical ultracentrifugation techniques have potential uses in drug discovery as well as clinical diagnostics. Typically, light based measurement techniques in ultracentrifuges such as absorbance, refractive, interference and fluorescence based schemes are used to analyze the concentration distribution of particles (e.g., proteins) in a sample as a function of time, during centrifugation. However, complex mixtures such as blood and spinal fluids contain a plurality of particles (e.g., proteins) having similar molecular weights, optical and other physical properties. The large number of particles within the mixture and their similarities makes it very difficult to use traditional experiments to distinguish and identify individual particles within a sample.

Also, ultracentrifuges can be expensive and require human involvement to interpret results obtained from the light based measurement techniques. Furthermore, there is currently no safe way for handling the samples which may be an important issue when handling infected blood samples in clinical diagnostic studies. Generally, an analytical ultracentrifuges that can be used for clinical diagnostics is not known to exist.

Accordingly, there is a need for a cheap and reliable analytical ultracentrifuge for clinical diagnostics and drug discovery. More specifically, there is a need for sample holders and detection systems that can be used in an analytical ultracentrifuge to make it safe and capable of detecting particles in complex mixtures.

### SUMMARY OF THE INVENTION

The systems and methods described herein include improved centrifuges, sample holders for centrifuges and improved methods to detect species in samples using centrifuges equipped with luminescence based measurement systems.

In one aspect, the invention provides sample holders for centrifuges that include a channel structure having a sample channel and an overflow channel. The sample channel and the overflow channel are configured such that any excess sample flows into the overflow channel thereby maintaining a constant sample level in the sample channel. In other aspects, the invention provides for centrifuges comprising sample holders having a plurality of channel structures. In still other aspects, the invention provides for methods of using the sample holder and methods for detecting species in a sample using luminescence based measurement techniques.

More particularly, in one aspect, the systems and methods described herein include a sample holder for a centrifuge. The sample holder comprises a substrate, having a sample channel and an overflow channel. The sample channel is formed within the substrate and includes a sample loading region and a sedimentation region. The overflow channel is formed within the substrate and connected to the sedimentation region of the sample channel. A portion of the overflow channel intersects the sedimentation region of the sample channel to form a fluid connection and thereby define a meniscus position. In one embodiment, the substrate has a detachable connection with a rotor of the centrifuge. The rotor may have a chamber and the substrate may removably fit into the chamber. The substrate may be formed in the shape of a rotor of the centrifuge. The substrate may have a detachable connection with a spindle of the centrifuge.

In one embodiment, the substrate may comprise at least one sample channel and at least one overflow channel formed onto a surface of the substrate. In such an embodiment, the overflow channel intersects the sample loading region of the sample channel to form a fluid connection and thereby equilibrate pressure in the overflow channel. Additionally and optionally, the overflow channel may intersect an opening in the substrate to form a fluid connection and thereby equilibrate pressure in the overflow channel.

The sample channel may be formed along a radial axis from a center of an axis of rotation of the centrifuge. In certain embodiments, a portion of the overflow channel is formed along an axis at an angle away from the radial axis. The angle between a portion of the overflow channel and the sedimentation region may be an acute angle.

In one embodiment, the sample holder may comprise a window covering at least one wall of at least one of the sample channel and the overflow channel. The window may be hermetically sealed to at least one of the sample channel and the overflow channel. The window may comprise an optically inert plastic material including at least one of quartz, sapphire and glass.

In one embodiment, the sample holder may comprise a material responsive to a sample. The sample holder may comprise a plurality of substrates and the substrate may be formed from a disposable material. The disposable material may be selected from the group consisting of epoxy, poly-di-methyl-siloxane (PDMS), polyisoprene, polybutadiene, polychloroprene, polyisobutylene, poly(styrene-butadiene-styrene), polyurethane, silicon, poly(bis(fluoroalkoxy)phosphazene), poly(carboranesiloxanes), poly(acrylonitrile-butadiene), poly(1-butene), poly(chlorotrifluoroethylene-vinylidene fluoride) copolymers, poly(ethyl vinyl ether), poly(vinylidene fluoride), poly(vinylidene fluoride-hexafluoropropylene) copolymer, polyvinylchloride (PVC), polysulfone, polycarbonate, polymethylmethacrylate (PMMA), polytetrafluoroethylene (Teflon), Phenolic Resin or Delrin. The substrate may include materials capable of withstanding centrifugation forces greater than 300,000 g.

The sample holder may comprise an identification panel on the substrate to distinguish samples from each other. The identification panel may include a bar code label. The sample holder may also comprise a sensor chip located near the sample channel. In one embodiment, the sample comprises a sensor chip integrally formed in the sample channel.

In one embodiment, the sedimentation region of the sample channel has a capacity of about 10 μL. The overflow channel may have a capacity of about ½ μL. In certain embodiments, the sample loading region has a larger capacity than the sedimentation region. The depth of the sample channel may be about 1 mm and the depth of the overflow channel may be about 300 μm. The substrate may have a plurality of sample channels and overflow channels. In certain embodiments, the width of the sample channel increases with radial distance from a center of an axis of rotation of the centrifuge. The width of the overflow channel may also increase with radial distance from a center of an axis of rotation of the centrifuge.

In another aspect, the invention provides methods of transferring a sample in a centrifuge. The method includes the steps of providing a sample holder for a centrifuge. In such an aspect, the sample holder comprises a substrate, having a sample channel and an overflow channel. The sample channel is formed within the substrate and includes a sample loading region and a sedimentation region. The overflow channel is formed within the substrate and is connected to the sedimentation region of the sample channel. A portion of the overflow channel intersects the sedimentation region of the sample channel to form a fluid connection and thereby define a meniscus position. The method also includes positioning the sample holder in the centrifuge with at least one sample channel substantially oriented along a radial direction from a rotating axis of the centrifuge. The method further includes operating the centrifuge such that a portion of the sample moves from the sample loading region to the sedimentation region and transferring an excess portion of the sample from the sedimentation region of the sample channel to the overflow channel such that a meniscus of the sample is maintained at a substantially constant position in the sedimentation region near the location of connection between the overflow channel and the sedimentation region.

In one embodiment, the sample loading region is closer to the center of the rotating axis than the sedimentation region to allow for samples to move from the sample loading region to the sedimentation region during the operation of the centrifuge. The method may further comprise the step of attaching a window covering at least one wall of at least one of the sample channel and the overflow channel. In certain embodiments, the step of attaching a window includes hermetically sealing it to at least one of the sample channel and the overflow channel. The method may comprise the step of adding a sample using a pipette. The sample may include at least one of a liquid, gas, nucleic acid, protein and blood.

In other aspects, the invention provides for centrifuges comprising a rotor and a sample holder. The sample holder may be detachably connected to the rotor. The sample holder may comprise a substrate, having a sample channel and an overflow channel. The sample channel is formed within the substrate and includes a sample loading region and a sedimentation region. The overflow channel is formed within the substrate and is connected to the sedimentation region of the sample channel. A portion of the overflow channel intersects the sedimentation region of the sample channel.

In one embodiment, the centrifuge may comprise a plurality of sample holders. The rotor may have a chamber and the sample holder removably fits into the chamber. The rotor may be formed from titanium and/or an epoxy composite. The rotor may also be formed from a material capable of withstanding centrifugation forces greater than 400,000 g.

In another aspect, the invention provides for centrifuges comprising a rotor, a sleeve detachably connected to the rotor and a sample holder. The sample holder may comprise a substrate, having a sample channel and an overflow channel. The sample channel is formed within the substrate and includes a sample loading region and a sedimentation region. The overflow channel is formed within the substrate and is connected to the sedimentation region of the sample channel. A portion of the overflow channel intersects the sedimentation region of the sample channel. The sample holder may be detachably connected to the sleeve. In one embodiment, the sleeve may be formed from titanium.

In another aspect, the invention provides for centrifuges comprising a rotor, including a substrate, having a sample channel formed within the substrate and further including a sample loading region and a sedimentation region, and an overflow channel formed within the substrate and connected to the sedimentation region of the sample channel. In such an aspect, the rotor may have a detachable connection with the spindle of the centrifuge.

In one aspect, the invention provides for methods of detecting a species in a sample. The methods comprise the steps of adding a luminophore to the sample to form a tagged sample such that the luminophore attaches to a species in the sample, providing a sample holder for a centrifuge, and adding the tagged sample to the sample holder. The sample holder comprises a substrate, having a sample channel formed within the substrate and including a sample loading region and a sedimentation region, and an overflow channel formed within the substrate and connected to the sedimentation region of the sample channel. The method also includes operating the centrifuge with the sample holder such that a meniscus of the tagged sample is maintained at a substantially constant position near the location of connection between the sample channel and the overflow channel, measuring luminescence from the tagged sample at a position on the sample channel and detecting a species in a sample attached to the luminophore based on the time taken to travel from the substantially constant meniscus position to the measurement position.

In such aspects the luminescence may be measured at a position on the sample channel along the radial direction from the rotating axis of the centrifuge. In one embodiment, the step of detecting the species includes calculating a velocity of the species based at least on the travel time, the meniscus position, the luminescence measurement position and an angular velocity of the centrifuge. The calculated velocity may be used to determine a molecular mass of the species. The calculated velocity may also be used to determine a concentration of the species. The sample may include at least one of blood, protein, cerebral spinal fluid, nucleic acid, urine and sputum. The species may include beta-amyloid protein and the luminophore may include at least one of Green fluorescent protein, Texas Red, Fluorescein, Coumarin, Indian Yellow, Luciferin, Rhodamine, Perylene, Phycobilin, Phycoerythrin, Umbelliferone, Stilbene, Alexa Fluor, Oregon Green, HiLyte Fluor, Th-T, DCVJ and quantum dots.

In another aspect, the invention provides methods of detecting a species in a sample, comprising adding an agent, bound to a luminophore, to the sample to form a tagged sample such that the agent binds to a species in the sample; providing a sample holder for a centrifuge and adding the tagged sample to the sample holder. The sample holder comprises a substrate, having a sample channel formed within the substrate and including a sample loading region and a sedimentation region, and an overflow channel formed within the substrate and connected to the sedimentation region of the sample channel. The method also includes operating the centrifuge with the sample holder such that a meniscus of the tagged sample is maintained at a substantially constant position near the location of connection between the sample channel and the overflow channel, measuring the luminescence from the tagged sample at a position on the sample channel and detecting a species in a sample attached to the agent based on the time taken to travel from the substantially constant meniscus position to the measurement position.

In such aspects, the luminescence is measured at a position on the sample channel along the radial direction from the rotating axis of the centrifuge. In one embodiment, the step of detecting the species includes calculating a velocity of the species based on the travel time, the meniscus position, the luminescence measurement position and an angular velocity of the centrifuge. The calculated velocity may be used to determine a molecular mass of the species. The calculated velocity may also be used to determine a concentration of the species. The sample may include at least one of blood, protein, cerebral spinal fluid, nucleic acid, urine and sputum. The species may includes at least one of a virus, a bacterium, a protozoan, an amoebae and protein. The agent may include at least one of a protein and a nucleic acid. The luminophore may include at least one of Green fluorescent protein, Texas Red, Fluorescein, Coumarin, Indian Yellow, Luciferin, Rhodamine, Perylene, Phycobilin, Phycoerythrin, Umbelliferone, Stilbene, Alexa Fluor, Oregon Green, HiLyte Fluor, Th-T, DCVJ and quantum dots.

In another aspect, the invention provides methods of detecting a species in a sample comprising the steps of adding a luminophore to the sample to form a tagged sample such that the luminophore attaches to a species in the sample; providing a sample holder for a centrifuge and adding the tagged sample to the sample holder. The sample holder comprises a substrate, having a sample channel formed within the substrate and including a sample loading region and a sedimentation region, and an overflow channel formed within the substrate and connected to the sedimentation region of the sample channel. The method includes operating the centrifuge with the sample holder, measuring luminescence from the tagged sample at two or more positions on the sample channel and detecting a species in a sample attached to the luminophore based on the time taken to travel from one measurement position to another measurement position.

### BRIEF DESCRIPTION OF THE DRAWINGS

The following figures depict certain illustrative embodiments of the invention in which like reference numerals refer to like elements. These depicted embodiments may not be drawn to scale and are to be understood as illustrative of the invention and not as limiting in any way.

FIG. 1 is a top view of a sample holder having a sample channel and an overflow channel according to one illustrative embodiment of the invention.

FIG. 2 depicts a three-dimensional perspective view of a sample holder of FIG. 1 according to one illustrative embodiment of the invention.

FIG. 3 is a zoomed-in perspective view of a sample channel and an overflow channel according to one illustrative embodiment of the invention.

FIG. 4 depicts a top view of a sample holder having a sample channel and an overflow channel according to another illustrative embodiment of the invention.

FIG. 5 depicts a three-dimensional perspective view of a centrifuge including a sample holder according to one illustrative embodiment of the invention.

FIG. 6 depicts a top view of a sample holder having a plurality of sample channels and a plurality of overflow channels according to one illustrative embodiment of the invention.

FIG. 7 depicts a three-dimensional perspective view of a centrifuge including a sample holder according to another illustrative embodiment of the invention.

FIG. 8A-8C depict top views of a sample holder showing the sample and the formation of a meniscus according to one illustrative embodiment of the invention.

FIG. 8D depicts a graph showing the concentration of the sample at various radial locations according to one illustrative embodiment of the invention.

FIG. 9 depicts a graph showing the concentration of the sample at various radial locations for multiple instances in time according to one illustrative embodiment of the invention.

FIG. 10 depicts an assembly of a sample holder and a window according to one illustrative embodiment of the invention.

FIG. 11 depicts a system for fluorescently detecting a species in a sample using a sample holder and a fluorescence detection system according to one illustrative embodiment of the invention.

FIG. 12 depicts a system for fluorescently detecting a species in a sample at two radial locations according to one illustrative embodiment of the invention.

### DETAILED DESCRIPTION OF ILLUSTRATED EMBODIMENTS

These and other aspects and embodiments of the systems and methods of the invention will be described more fully by referring to the figures provided.

The systems and methods described herein will now be described with reference to certain illustrative embodiments. However, the invention is not to be limited to these illustrated embodiments which are provided merely for the purpose of describing the systems and methods of the invention and are not to be understood as limiting in anyway.

As will be seen from the following description, in one aspect, the invention provides sample holders for centrifuges that include a channel structure having a sample channel and an overflow channel. The sample channel and the overflow channel are configured such that any excess sample from the sample channel flows into the overflow channel thereby maintaining a constant sample level in the sample channel. In other aspects, the invention provides for centrifuges comprising sample holders having a plurality of channel structures. In still other aspects, the invention provides for methods of using the sample holder and methods for detecting species in a sample using luminescence based measurement techniques.

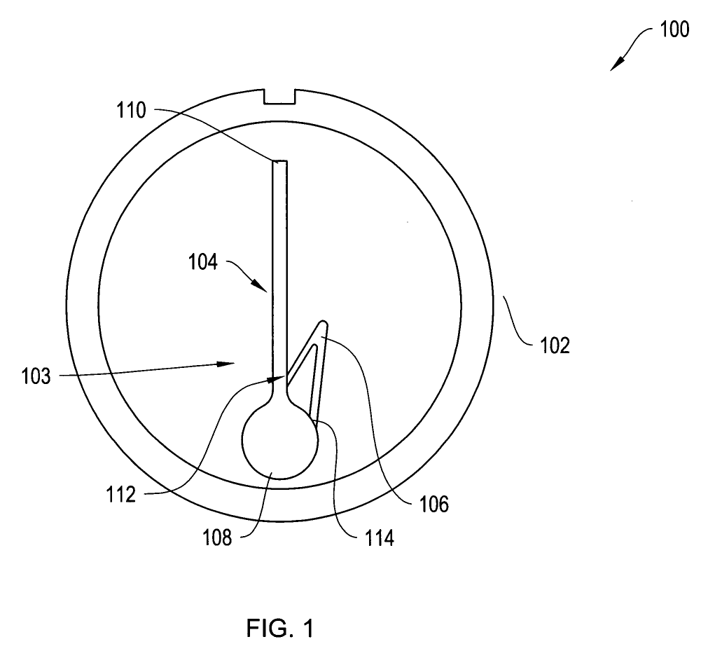

FIGS. 1, 2 and 3 depict different views of a sample holder for a centrifuge according to one illustrative embodiment of the invention. In particular, FIG. 1 depicts a top view of a sample holder 100 having a channel structure 103 formed in a substrate 102. The channel structure includes a sample channel 104 and an overflow channel 106. The sample channel 104 has a sample loading region 108 and a sedimentation region 110. The overflow channel 106 is in fluid connection with the sedimentation region 110 of the sample channel 104 at overflow connection 112. The overflow channel 106 is also shown to be connected to the sample loading region 108 at pressure balance connection 114. In one embodiment, the sample holder 100 may be placed in a centrifuge such that the sample channel 104 is oriented substantially along the radial direction from the axis of rotation. In such an embodiment, a sample that is placed in the sample loading region 108 prior to the operation of the centrifuge, may move from the sample loading region 108 to the sedimentation region 110 during the operation of the centrifuge. An excess amount of sample in the sedimentation region 110 overflows into the overflow channel 106, thereby maintaining a constant sample level near the overflow connection 112.

The sample channel 104 may be formed at any location on the substrate 102 and includes a bulb shaped sample loading region 108 and a substantially rectangular or sector-shaped sedimentation region 110. The sample channel 104 may be formed within the substrate through etching processes. The channel structure 103 may also be formed on the surface of the substrate through suitable deposition processes. The sample loading region 108 and the sedimentation region 110 may be sized and shaped differently without departing from the scope of the invention.

The overflow channel 106 has two arms extending at an acute angle and is shown to be connected to the sample channel 104 at two locations. The orientation of the overflow channel 106 is shown to be at angle away from the sedimentation region 110 of the sample channel 104. The orientation of the overflow channel 106 is selected based at least in part on the orientation of the sample channel 104 and the requirements of the particular application. In one implementation, the sample holder 100 is used in a centrifuge such that the sample channel 104 is oriented substantially along the radial direction from the axis of rotation. In such an implementation, the arm of the overflow channel connected to the sedimentation region 110 of the sample channel 104 is oriented at an acute angle away from the sedimentation region 110. During the operation of a centrifuge in such an implementation, a sample may experience gravitational forces along the length of the sedimentation region 110. A sample flowing through the sample channel 104 may travel through the sedimentation region 110 until such time that the sedimentation region fills up. The sample may then travel into the overflow channel which is oriented at just a small angle away from the direction of gravitational forces.

The overflow channel 106 also connects to the sample loading region 108 at pressure balance connection 114. In one embodiment, the pressure balance connection 114 helps equilibrate the pressure in the channel structure 103 and allows fluid to flow into the overflow channel 106 through overflow connection 112.

The overflow channel 106 may be connected to the sample channel 104 at different locations along the sedimentation region 110 without departing from the scope of the invention. The overflow channel 106 may have a plurality of arms and may have different shapes depending on the requirements of a particular application. The overflow channel 106 functions to allow excess sample to flow out of the sample channel 104 and therefore, may be shaped, sized, arranged and oriented in any suitable manner without departing from the scope of the invention.

The shape and size of the sample holder 100 is chosen based at least in part on the shape and size of the centrifuge assembly with which it is typically used. In one embodiment, the sample holder 100 may be detachably connectable to a rotor in the centrifuge. The rotor may have a suitable chamber or cavity within which the sample holder 100 may fit. The sample holder 100 is shown to be substantially circular in shape when viewed from above.

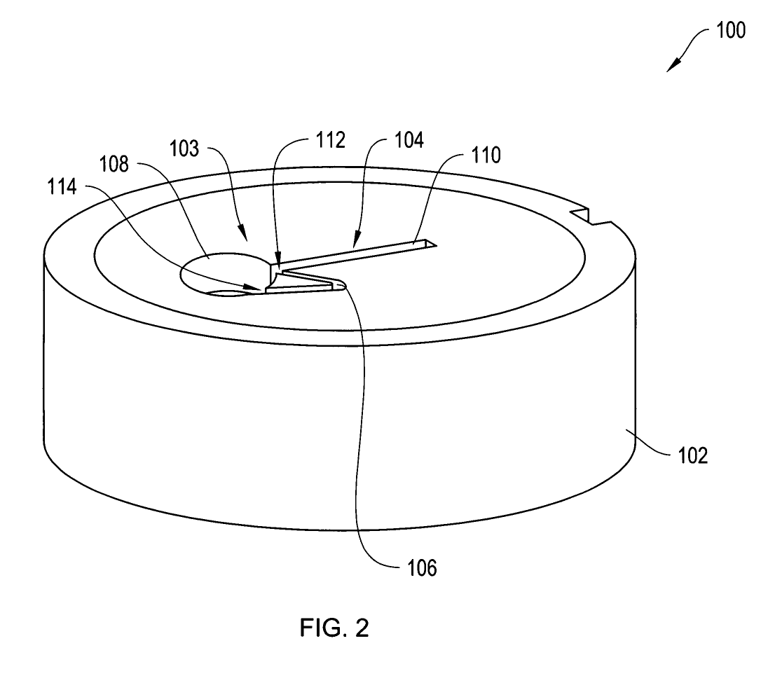

FIG. 2 depicts a three-dimensional view of the sample holder 100 of FIG. 1 having a channel structure 103 including a sample channel 104 and an overflow channel 106 according to one illustrative embodiment of the invention. The channel structure 103 is shown to be etched within the substrate 102. The sample channel 104 is connected the overflow channel 106 at overflow connection 112 and pressure balance connection 114.

The substrate 102 is cylindrically shaped with a circular top as depicted in FIG. 1 and having a thickness. The substrate 102 may be shaped differently to fit within a centrifuge assembly. In certain embodiments, the sample holder 100 may have a detachable connection with a rotor of the centrifuge. In such embodiments, substrate 102 may be shaped to fit within the chambers in the rotor.

The substrate 102 may be formed from one or more materials capable of withstanding centrifugation forces greater than 300,000 g. The substrate 102 may be made of a suitable elastomeric material. Suitable elastomeric materials are typically substantially liquid impermeable. Furthermore, suitable substrate 102 materials may be non-reactive. Non-reactive materials do not react, or only minimally react, biochemically with a sample. This biochemical non-reactivity is distinguishable from adherence that may occur between certain samples and certain materials due, for example, to electrostatic interactions. In certain embodiments, the substrate 102 material can be coated with one or more agents. Exemplary agents such as Teflon help decrease adherence between the material and the sample. In certain embodiments, all or a portion of the substrate 102 can be coated with one or more agents designed to promote the stability of the sample. Exemplary agents include, but are not limited to, RNase inhibitors to prevent degradation of RNA samples; DNase inhibitors to prevent degradation of DNA samples, protease inhibitors to prevent degradation of protein samples; anti-microbial agents to prevent microbial infections that can degrade any biological sample; and anti-fungal agents to prevent fungal infections that can degrade any biological sample. For any of the foregoing examples involving the coating of the substrate 102 with one or more agents, the systems may include embodiments in which the agents are added to the substrate 102 material and incorporated within the material during the fabrication process, as well as embodiments in which the substrate 102 that are coated with agents post-fabrication.

In certain embodiments, the substrate 102 is formed from or coated with a material that is physically, chemically or biologically reactive and particularly responsive to the sample. Substrate materials may include at least one of immobilized ions, antibodies, enzyme substrates, ligands, polyelectrolytes, hydrophobic matrices. These materials typically present an immobile phase to which specific components of the sample may bind reversibly or irreversibly, and thereby may increase the time needed for them to sediment. Substrate materials may be selected based, at least in part, on the desired application. Example applications for these surfaces may include sample sub-fractionation, removal of interfering agents and reactive conversion of sample components for improved detection.

In one embodiment, the substrate is formed from disposable material. The material for the substrate 102 may be selected from a group comprising epoxy, poly-di-methyl-siloxane (PDMS), polyisoprene, polybutadiene, polychloroprene, polyisobutylene, poly(styrene-butadiene-styrene), polyurethane, silicon, poly(bis(fluoroalkoxy)phosphazene), poly(carboranesiloxanes), poly(acrylonitrile-butadiene), poly(1-butene), poly(chlorotrifluoroethylene-vinylidene fluoride) copolymers, poly(ethyl vinyl ether), poly(vinylidene fluoride), poly(vinylidene fluoride-hexafluoropropylene) copolymer, polyvinylchloride (PVC), polysulfone, polycarbonate, polymethylmethacrylate (PMMA), polytetrafluoroethylene (Teflon), Phenolic Resin and Delrin.

The substrate 102 may further include sensors and identifiers located near the channel structure 103. In one embodiment, the substrate 102 includes an identification panel such as a bar code label to identify the channel structure 103 nearby. The substrate 102 may include temperature, pressure and chemical sensors disposed near the channel structures 103. The sensors may also be disposed within the sample channel 104 or the overflow channel 106.

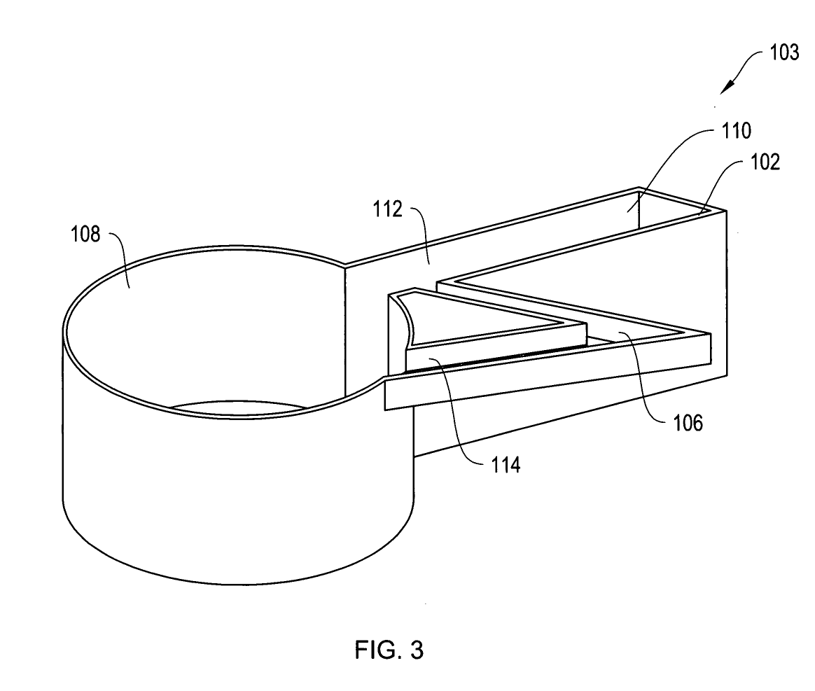

FIG. 3 depicts a zoomed-in three-dimensional view of the channel structure 103 having a sample channel 104 and an overflow channel 106 according to one illustrative embodiment of the invention. In particular, FIG. 3 more clearly points out some depths and volumes for the channel structures 103 in the sample holder 100. In one embodiment, the sample channel 104 has a depth of about 1 mm. In other embodiments, the sample channel 104 may have a depth greater or less than 1 mm depending on the requirements of the particular application. The overflow channel 106 may be less deep than the sample channel 104. The overflow channel 106 may have a depth of about 300 μm. The overflow channel 106 may have a depth greater or less than 300 μm. In one embodiment, the sedimentation region 110 of the sample channel 104 has a capacity of about 10 μL. The overflow channel 106 may have a capacity of about ½ μL. The size, shape and dimensions of the sample channel 104 and the overflow channel 106 may be chosen based at least in part on the requirements of the particular application without departing from the scope of the invention. The capacity requirements of the overflow channel may be selected based at least in part on the capacity of the pipette used to load the sample into the sample loading region 108. In one embodiment, channel structure 103 may be formed in a substrate 102 to create a sample holder 100. In such an embodiment, during operation, a sample in the channel structure 103 can experience centrifugation forces along the length of the sedimentation region 110 away from the sample loading region 108. The sample moves into the sedimentation region 110 until the amount of sample exceeds the sedimentation region's 110 capacity. Any excess sample then flows into the overflow channel 106 and creates a meniscus or level at the overflow connection 112. The excess sample is allowed to flow into the overflow channel 106 because the pressure in the overflow is kept favorable through the pressure balance connection 114.

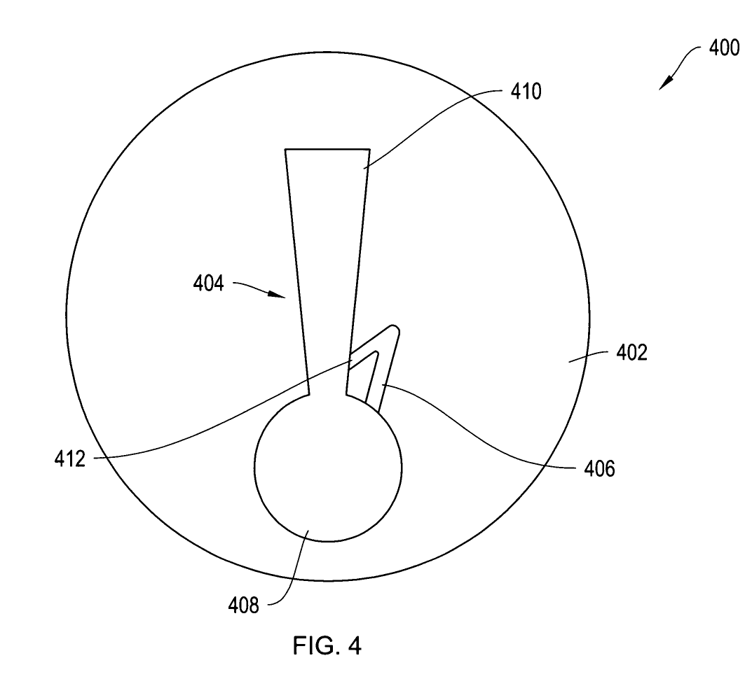

The movement of the sample in the sample channel 104 in the presence of a gravitational field generated by a centrifuge may be assisted by the shape of the sample channel 104. Generally, rotating centrifuges generate gravitational fields along a radial direction away from the center of the axis of rotation. The sample channel 104 may be shaped to increase or decrease the ease with which the sample moves in the sample channel 104 in the radial gravitational field. FIG. 4 shows a sample channel 104 having a sector shape to more particularly align with the radial gravitational field lines.

FIG. 4 depicts a top view of a sample holder 400 having a sample channel 404 and an overflow channel 406 formed within a substrate 402 according to another illustrative embodiment of the invention. The overflow channel 406 is connected to the sample channel 404 at the overflow connection 412 along the sedimentation region 410. The overflow channel 406 is also connected to the sample channel 404 at the pressure balance connection 414 along the sample loading region 408. The sedimentation region 410 is shown to be sector shaped such that the sedimentation region 410 tapers near the sample loading region 408. During operation, as the sample moves from the sample loading region 408 into the sedimentation region 410, it generally tends to follow the lines of the gravitational fields along the radial direction. The sedimentation region 410 is sector shaped and widens away from the sample loading region 408. Therefore, as the sample moves through the sedimentation region 410, it undergoes fewer collisions with the sidewalls. The sample channel 404 and the overflow channel 406 are formed from similar materials to sample channel 104 and overflow channel 106, respectively of FIG. 1.

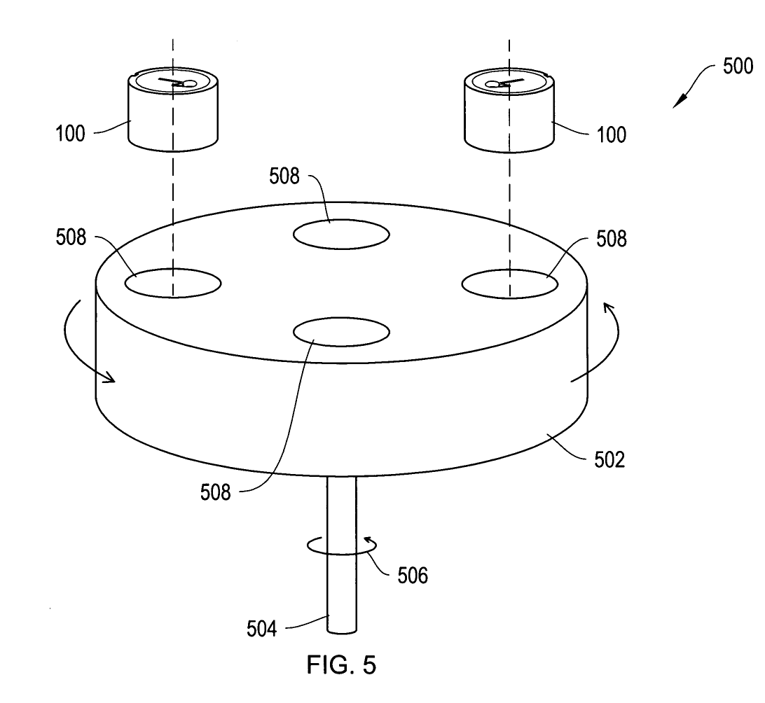

FIGS. 5, 6 and 7 depict sample holders and centrifuge assemblies capable of analyzing a plurality of samples. FIG. 5 depicts a three-dimensional view of a centrifuge assembly 500 including a plurality of sample holders 100 arranged in a rotor 502. The rotor 502 is shown to be connected to a shaft 504 such that the rotor 502 and the shaft 504 rotate in a direction shown by arrow 506. The rotor 502 includes a plurality of chambers 508 such that the sample holder 100 removably fits within the chamber 508.

The sample holders 100 may be placed in the chambers 508 such that the sample loading region of the sample channel in the sample holder 100 is closer to the shaft 504 and the sedimentation region of the sample channel in the sample holder 100 is aligned substantially along the radial direction from the center of the disc shaped rotor 502. The sample holders 100 may be placed in other orientations depending on the requirements of the specific application.

The rotor 502 is shown to be disc shaped and having chambers 508 to accommodate the sample holders 100. The rotor 502 may be formed from rigid and resilient material including titanium and epoxy composites.

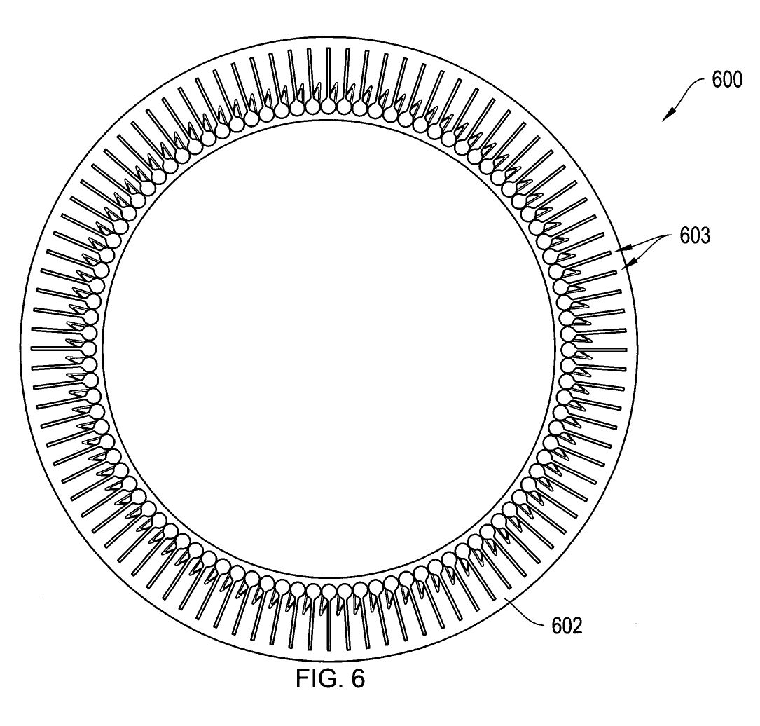

FIG. 6 depicts a top view of a sample holder 600 having a plurality of sample channels 602 according to one illustrative embodiment of the invention. In particular, the sample holder 600 is shown to include a ring shaped substrate 602 having about ninety-six channel structures 603. The sample holder 600 may be similar to sample holder 100 of FIG. 1. The substrate 602 may be formed from similar materials to substrate 102 of FIG. 1. The channel structures 603 are formed similarly to channel structures 103 of FIG. 1. The sample holder 600 may be sized and shaped to fit directly with a rotor of a centrifuge. In some embodiments, the sample holder 600 may be formed from resilient materials such that it may function as a rotor in the centrifuge. In such embodiments, the sample holder 600 is configured to couple to a shaft of the centrifuge. In certain embodiments, the sample holder 600 is sized and shaped to couple indirectly to a rotor of a centrifuge

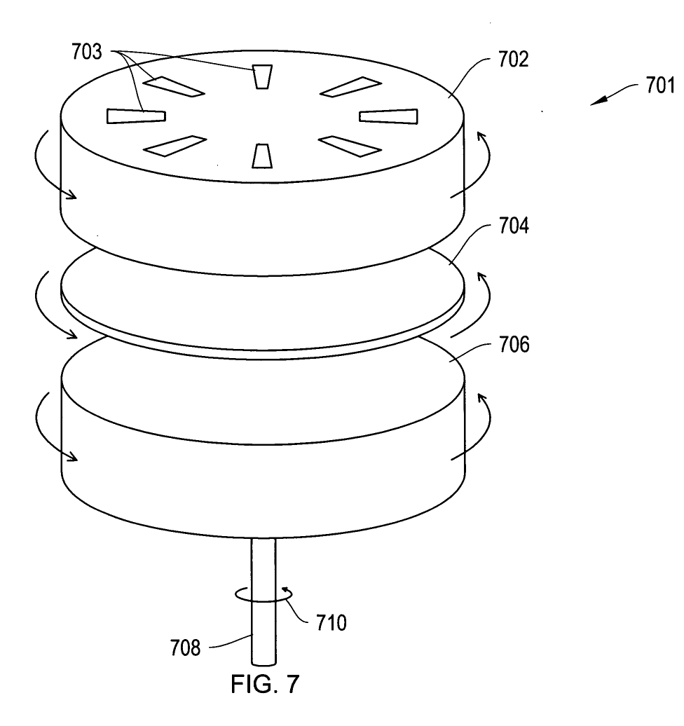

FIG. 7 depicts a three-dimensional view of a centrifuge assembly 700 according to another illustrative embodiment of the invention. The assembly 700 comprises a sample holder 701, a rotor 706 and a sleeve 704 attached therebetween. The sleeve 704 helps attach the sample holder 701 to the rotor 706. The sample holder includes a substrate 702 having one or more channel structures 703 formed therein. The sample holder 701, the sleeve 704 and the rotor 706 are coupled to a centrifuge shaft 708 such that they may rotate about the shaft in directions shown by arrow 710.

The sample holder 701 may be similar to sample holder 100 of FIG. 1. The substrate 702 may be formed from similar materials to substrate 102 of FIG. 1. The channel structures 703 are formed similarly to channel structures 103 of FIG. 1. In one embodiment, the sample holder 701 has a plurality of channel structures 703, similar to the sample holder 600 of FIG. 6.

The sleeve 704 may be sized and shaped to accommodate the sample holder 701 and fit securely onto the rotor 706. The sleeve 704 may be formed from suitable rigid materials including titanium.

The sample holder of FIG. 1-7 may be used together with a suitable luminescence based measurement system in a centrifuge to study the temporal variations of the concentration distribution in a sample.

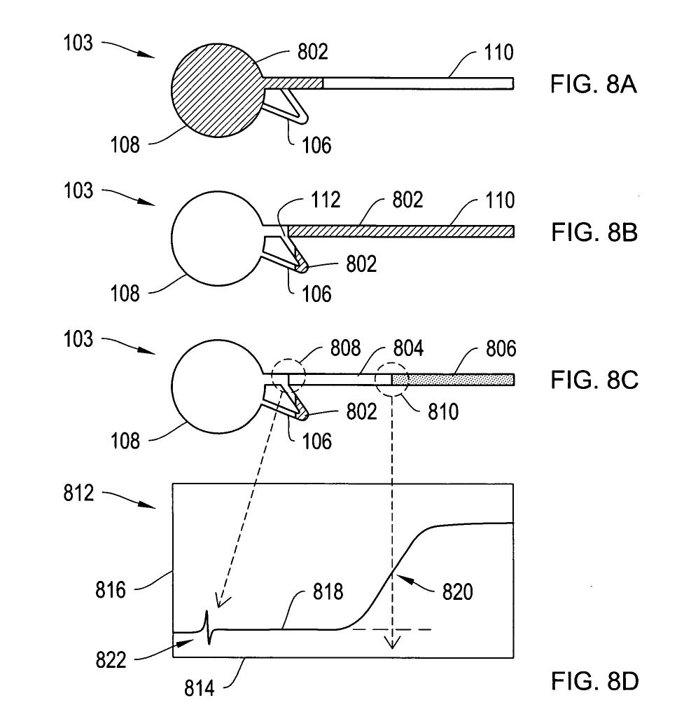

FIG. 8A-8C depict a channel structure 103 and the movement of the sample from the sample loading region to the sedimentation region along with the overflow of any excess sample into the overflow region. In particular, FIG. 8A shows the sample 802 substantially in the sample loading region 108 and a partially in the sedimentation region 110. During the operation of a centrifuge, the sample 802 flows from the sample loading region 108 to the sedimentation region 110. The sample 802 fills the sedimentation region and overflows in to the overflow channel 106. FIG. 8B shows the sedimentation region 110 filled with sample 802. The meniscus of the sample 802 coincides with the overflow connection 112. Any excess sample 802 from the sedimentation region flows into the overflow channel 106.

As the centrifuge operates, generating more gravitational forces on the sample 802, the solute 806 and the solvent 804 in the sample 802 begin to separate. FIG. 8C shows the separation of the solvent 804 and the solute 806 in the sedimentation region 110. As centrifugation continues, the solute 806 begins to sediment at one end of the sedimentation region 110. The meniscus 808 is maintained near the overflow connection 112 while the solute boundary 810 moves away from the sample loading region 108.

FIG. 8D depicts a chart 812 of absorbance measurements of the sample 802 at a particular time instant during centrifugation according to one illustrative embodiment of the invention. The horizontal axis 814 represents the radial distance from the center of the axis of rotation of the centrifuge. The vertical axis 816 represents the absorbance reading obtained from the sample 802 during the centrifugation process. In particular, during centrifugation, the sample is illuminated with light having one or more wavelengths and the light absorbed by the sample is measured as absorbance. The absorbance metric helps provide a measurement of the concentration of the substance at various radial locations. The absorbance curve 818 corresponds to the concentration distribution of the sample 802 in the sedimentation region 110 of the sample holder 102. The absorbance curve 818 includes a some spikes in measurement near the location of the meniscus 808. The absorbance curve 818 also depicts the sedimentation boundary 820. An advantage of the invention is that the meniscus 808 and the related spike 822 in the absorbance measurement are relatively fixed and therefore reliable measurements can be made to automatically determine the exact meniscus location with little or no human involvement.

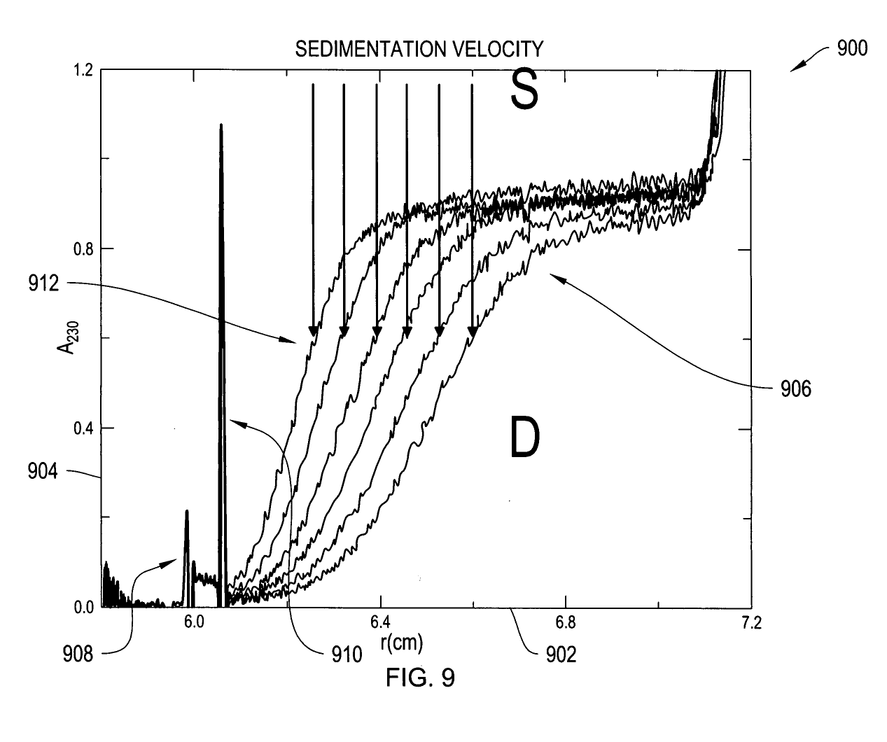

FIG. 9 depicts a more detailed plot 900 of the absorbance versus the radial distance according to one illustrative embodiment of the invention. The plot 900 may be used to calculate the sedimentation velocity of the solute 806. In particular, the horizontal axis 902 shows the radial distance from the center of the axis of rotation and the vertical axis 904 shows the value of absorbance. Each of the curves 906 show the value of absorbance being measured at the various locations along the radial direction. The plurality of curves 906 represent absorbance measurements taken along the length of the sample channel 104 at a plurality of instances in time. The characteristic shape of the sedimentation curve 906 depicts an increased absorbance in the region of the solute 806 and a low absorbance in the region of the clear solvent 804. The sedimentation boundary 912 is the region between the high absorbance measurements and the low, almost zero, absorbance measurements. During the centrifugation process, the sedimentation boundary 912 (or solute boundary 810) moves away from the meniscus 808. The meniscus 808 is identified in the absorbance curve 906 as spike 910. In certain embodiments, a reference channel containing a solvent 804 may be included in the sample holder 100. The meniscus of the reference channel solvent may also be identified in the absorbance curve as spike 908. In other embodiments, the spikes 908 and 910 may overlap.

As noted earlier, the boundary 912 tends to move along the radial direction as time passes. The rate at which the sedimentation boundary 912 moves is typically a measure of the sedimentation coefficient of the solute. The sedimentation coefficient typically depends on the molecular weight (larger molecules typically sediment faster) and also on molecular shape, size and concentration. As an example, unfolded proteins or proteins with elongated shapes generally experience more hydrodynamic friction, and thus have smaller sedimentation coefficients than a folded, globular protein of the similar molecular weight. In one embodiment, the slope of the boundary 912 may decrease with the passing of time. In such embodiments, the boundary region 912 tends to become wider resulting in boundary spreading. The rate of boundary spreading typically helps yield the diffusion coefficient of the solute in the sample. Additionally the rate of boundary spreading may be influenced by the presence of multiple solute species with similar sedimentation coefficients. This generally causes the boundary 912 to become broader than expected on the basis of diffusion alone.

In general, absorbance measurements use the absorbance of a solute to determine the temporal variation of its concentration along a sample channel 104. In certain embodiments, fluorescence and refractive measurements are also used to determine the temporal variation of concentration along a sample channel 104. Such light based measurement techniques typically require visual inspection of the sample during measurement. In particular, light beams have to impinge on the sample and the light emitted from the sample has to be collected. Sample holders 100 may be assembled with transparent windows to allow light to pass through and from the sample.

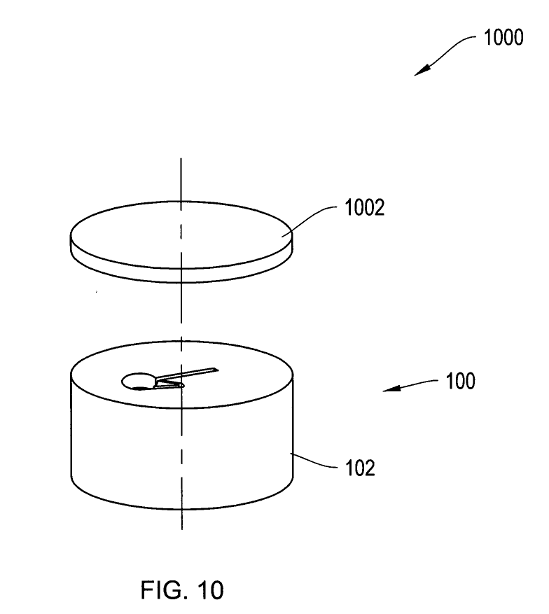

FIG. 10 depicts an assembly of a sample holder and a window according to one illustrative embodiment of the invention. The assembly 1000 shows a sample holder 100 formed from a substrate 102 being attached to a window 1002. In one embodiment, the window 1002 is hermetically sealed to the top of the substrate 102 such that the sample channel 104 and the overflow channel 106 are sealed. In certain embodiments, the window 1002 includes an optically inert plastic material. In another embodiment, the window 1002 includes rigid transparent materials such as quartz, sapphire and glass.

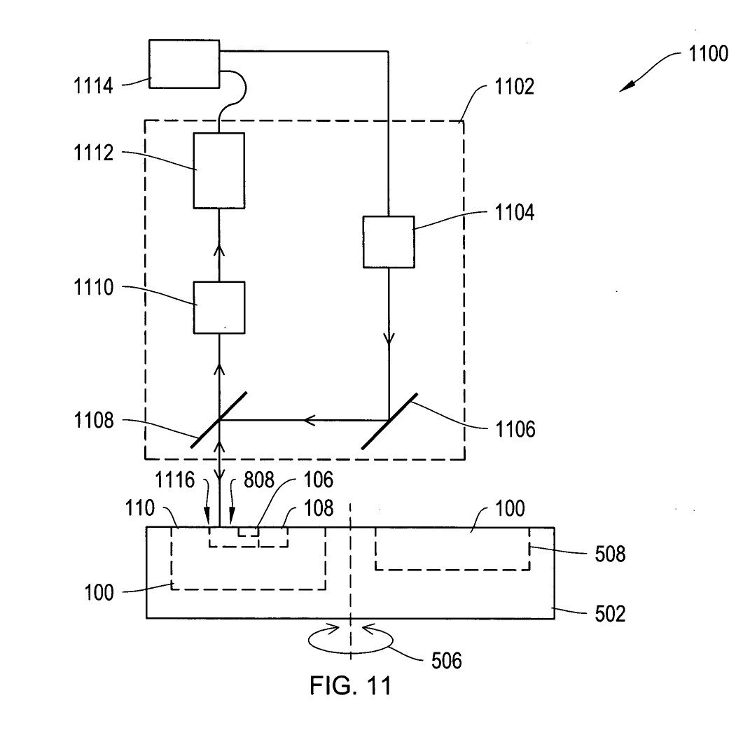

The window 1002 may be sized and shaped to fit on top of the substrate. In some embodiments, the window 1002 may cover a portion of the substrate 102. A plurality of windows 1002 may be used either on top of the substrate 102, below the substrate 102 or both above and below the substrate 102. The transparent window functions to keep the sample within the sample channel 104 during centrifugation as well as allow for luminescence measurements to be made on the sample as described further in FIG. 11.

FIG. 11 depicts a system for fluorescently detecting a species in a sample using a sample holder and a fluorescence measurement system 1100 according to one illustrative embodiment of the invention. The system 1100 includes an optical system 1102 having a light source 1104, a mirror 1106, a beam splitter 1108, a filter bank 1110 and a photomultiplier tube (PMT) 1112. The optical system 1102 is connected to a computer terminal 1114 that operates the light source 1104, receives data from the PMT 1112 and controls the position of various optical elements. Beams originating from the light source 1104 in the optical system 1102 are directed using mirror 1106 and beam splitter 1108 towards the sample located within the sedimentation region 110 of the sample holder 100. The beam impinges on the sample at measurement position 1116. One or more sample holders 100 may be configured within the rotor 502 and therefore one or more sample may be observed and analyzed while the centrifuge operates and the rotor spins. The light emitted from the sample then passes through the beam splitter 1108 and into a filter bank 1110 to further refine the quality of the signal. The filtered optical signal is detected at the PMT 1112 and then sent to a computer terminal 1114 for processing.

In one embodiment, the optical measurement system uses co-axial excitation and emission similar to confocal fluorescent microscopes. Therefore, in other embodiments, the optical measurement system 1100 may be replaced by a confocal fluorescent microscope without departing from the scope of the invention.

In one embodiment, the light source 1104 includes a laser. The laser may be a continuous 50 mW Ar⁺ laser tuned to about 488 nm. One example of such a laser is a 532-AP-OAR-AAM laser manufactured by Omnichrome, Inc., Carlsbad, Calif. The light source may also include a Xenon light source. In certain embodiments, the light source 1104 includes a pulsed light source. In other embodiments, the light source(s) 1104 may include an arc lamp, an incandescent bulb which also may be colored, filtered or painted, a lens end bulb, a line light, a halogen lamp, a light emitting diode (LED), a chip from an LED, a neon bulb, a fluorescent tube, a fiber optic light pipe transmitting from a remote source, a laser or laser diode, or any other suitable light source. Additionally, the light sources 1104 may be a multiple colored LED, or a combination of multiple colored radiation sources in order to provide a desired colored or white light output distribution. For example, a plurality of colored lights such as LEDs of different colors (red, blue, green) or a single LED with multiple colored chips may be employed to create white light or any other colored light output distribution by varying the intensities of each individual colored light. The light source 1104 may be coupled into an optical fiber which delivers the light to the remaining optical elements in the optical system 1102. The optical fiber includes a 3.5 μm glass, single-mode fiber such as a SMJ-33-488-3.5/125-3-5-SP manufactured by Oz Optical, Ottawa, Ontario, Canada.

The tip of the optical fiber is typically located at the focal point of a collimating lens. Excitation light from the light source 1104 generally spreads into a cone that is collimated using the collimating lens. The collimated beam of excitation light is then directed towards the mirror 1106. In one embodiment, the mirror is a silver elliptical mirror that may be optionally attached to an adjustable mirror holder. The mirror 1106 redirects the beam of excitation light towards the beam splitter 1108.

In one embodiment, the beam splitter 1108 includes a dichroic beam splitter attached to an adjustable mirror holder. The dichroic beam splitter 1108 selectively reflects light below a certain wavelength while passing light from the remaining wavelengths. In one embodiment, the dichroic beam splitter 1108 reflects about 95% of the light at wavelengths shorter than about 490 nm. The beam of excitation light is reflected by the dichroic beam splitter and directed towards the sample holder 100. In one embodiment, a condenser lens is placed between the beam splitter 1108 and the sample holder 100 such that the excitation light is focused on the sample holder 100. The condenser lens may also serve as an objective lens to receive light emitted by the sample in response to the impinging excitation beam of light.

The fluorescing sample may emit light in a plurality of directions at typically longer wavelengths than the beam of excitation light. Light emitted from the sample is collimated by an optional objective lens (e.g., the condenser lens) and passed through the beam splitter 1108.

The collimated emission light may be refocused and passed through a filter bank 1110. In one embodiment, the filter bank 1110 includes long-pass filters having greater than 95% transmittance at wavelengths greater than 505 nm. The filter bank 1110 also includes spatial filters positioned near to the PMT 1112.

The PMT 1112 converts the emission beam in the form of optical signals to electrical signals. Therefore, any detector capable of converting optical signals to electrical signals may be used as a PMT 1112 without departing from the scope of the invention. In certain embodiments, the detector may include at least one of a charge coupled device (CCD), a CMOS detector and a photodiode.

Electrical signals from the PMT 1112 may initially be processed by electronics for buffering, amplification and signal conditioning. The electronics may be integral within the computer terminal 1114. The computer terminal 1114 may also include other electronic circuitry to digitize and store the analog electrical signals received from the PMT 1112. The computer terminal 1114 may include any computer system having a microprocessor, a memory and a microcontroller. The memory typically includes a main memory and a read only memory. The memory may also include mass storage components having, for example, various disk drives, tape drives, etc. The mass storage may include one or more magnetic disk or tape drives or optical disk drives, for storing data and instructions for use by the microprocessor. The memory may also include one or more drives for various portable media, such as a floppy disk, a compact disc read only memory (CD-ROM), or an integrated circuit non-volatile memory adapter (i.e. PC-MCIA adapter) to input and output data and code to and from microprocessor. The memory may also include dynamic random access memory (DRAM) and high-speed cache memory.

In one embodiment, the computer terminal 1114 includes data acquisition circuitry capable of being synchronized with the rotor of the centrifuge. In such an embodiment, the rotor may include Hall Effect sensors capable of generating rotor timing pulses. The leading edge of these rotor timing pulses clocks an electronic circuit whose output may be a square wave with a period equal to one revolution of the rotor. The square wave provides a gating signal for data acquisition. In one embodiment, digitized signals are acquired into a data storage module. In such embodiments, an additional pre-triggering circuit enables storage of data digitized for a period preceding the edge of the gating signal, thereby ensuring that data are obtained from a complete rotation. The computer terminal 1114 includes software to allow for data from several consecutive turns of the rotor to be accumulated in the memory module.

The computer terminal 1114 may be connected to operate the light source in either a continuous mode or a pulsed mode. The computer terminal 1114 may also be connected to other optical elements within the optical system 1102 including the adjustable mirror holders supporting the mirror 1106 and the beam splitter 1108.

As noted above, the light source 1104 in the fluorescent measurement system 1100 may be operated in a continuous mode or in a pulsed mode or a combination thereof. The choice of mode may depend at least from the requirements that the signal received has to be synchronized with the spinning rotor and signals from different sample have to be isolated from one another. One mode may be selected over another based at least in part on quantity and quality of data desired. In one embodiment, the light source 1104 is operated in continuous mode and the signals from different samples are separated from one another by synchronizing the detector with the spinning motor. A multiplexing circuit may be employed to separate portions of the detector signal corresponding to moments when a particular sample is in the light beam. In another embodiment, the light source 1104 is operated in a pulsed mode. In such an embodiment, the pulsed light source 1104 is triggered when a sample is aligned with the detector. In another embodiment, the light source and detector are operated in a continuous manner, with the detector data stored in computer memory, and the signals from the samples separated by software.

In certain optional embodiments, the optical system 1102 can be mounted on any suitable stepping motor-driver stage. Such a stage may be controlled by the computer terminal 1114 using a stepping motor controller. The optical system 1102 and the stepping motor stage may attach to two or more mounting posts that are mounted to a base plate of an optional vacuum chamber of the centrifuge. In certain embodiments, the posts may be designed to allow the entire optical system 1102 to be removed and replaced in the vacuum chamber while minimizing positional accuracy. With such a movable optical system 1102, the fluorescent measurement system 1100 may be configured to perform a radial scan of the sample channel 104 during operation.

The fluorescent measurement system 1100 may be particularly useful in measuring trace quantities of solute in a solvent. A small amount of solute may be fluorescently labeled and its boundary may be tracked in such a system as described above. The fluorescent measurement system 1100 may also be useful in tracking a particular species within a sample that contains a large number of species. In samples with a large number of species (e.g., blood having a plurality of proteins), sedimentation velocity experiments are difficult to perform because the sedimentation boundaries are typically blurred and difficult to track. In such samples, the species of interest have to be tracked separately.

In tracking individual species in a sample having a complex mixture of species, the characteristics of the species may be estimated based at least on the velocity of the sample. The velocity of the species may be calculated based on the time taken for the species to travel from one position on the sedimentation region 110 of the sample channel 104 to another position. In one embodiment, the initial position of the species is fixed at the meniscus position 808 determined by the overflow connection 112. A second position of the species may be adjustably selected as the measurement position 1116. The measurement position 1116 is controlled by the operation of the fluorescent measurement system 1100. During centrifugation and sedimentation, the species may move from the initial position determined by the location of the meniscus to a second position determined by the location of measurement. The time taken for the species to travel this distance may be calculated and used to determine the velocity of the species. The velocity of the species can be defined in terms of a sedimentation coefficient, S, given by the formula:

$$S = \frac{ln [ \frac{measurement position}{meniscus position} ]}{{ω}^{2} t}$$

where ω is angular velocity of the centrifuge rotor and t is the time taken for the species to travel from the meniscus position 808 to the measurement position 1116, measurement position is the radial distance from the center of the axis of rotation of the centrifuge to the measurement position 1116 and meniscus position is the radial distance from the center of the axis of rotation of the centrifuge to the meniscus position 808.

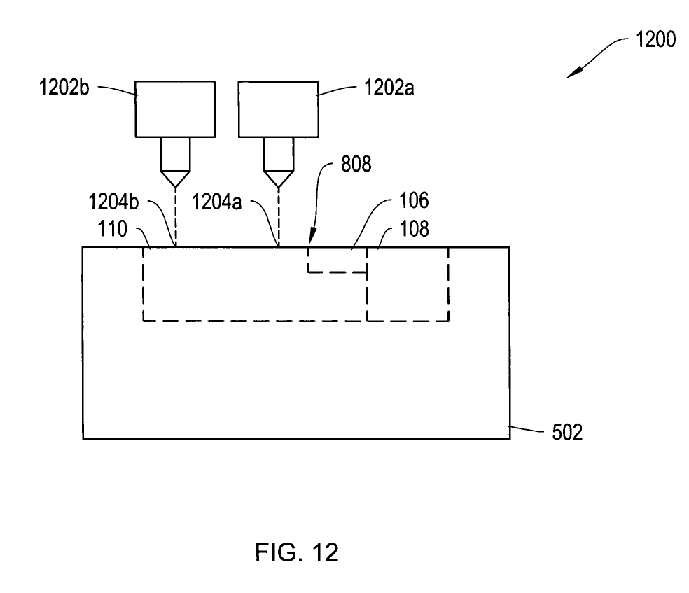

One or more measurement positions 1116 may be implemented to calculate the sedimentation velocity of a species in a sample. FIG. 12 depicts a system 1200 for fluorescently detecting a species in a sample at two radial locations according to one illustrative embodiment of the invention. In particular, the fluorescence measurement system 1200 includes two optical systems 1202a and 1202b fixed at two locations along the length of the sample channel 104. The two locations represent measurement positions 1204a and 1204b for each the optical systems 1202a and 1202b, respectively. The optical systems 1202a and 1202b are similar to optical system 1102 of FIG. 11. During operation, the sedimentation velocity of a species in a sample can be calculated based on the time taken for the species to travel from one measurement position 1204a to another measurement position 1204b. The sedimentation velocity obtained from such a calculation can be compared to the sedimentation velocity obtained using the meniscus position 808.

The sedimentation coefficient may be used to determine, among other things, the molecular mass of the species, the size of species, the shape of the species and the concentration of the species. The fluorescent measurement system 1100 of FIG. 11 in combination with the meniscus defining sample holder 100 in a centrifuge may be used for clinical diagnostics to study certain samples such as blood and detect the presence of certain species present in these samples.

### Direct Dye-Labeling

In one implementation, a labeling agent such as a luminophore may be added to the sample to form a tagged sample. The luminophore may bind itself to a species in the sample. In certain embodiments, the sample includes at least one of blood, protein, cerebral spinal fluid, nucleic acid, urine and sputum. The species of interest, in such embodiments, may be a protein such as a beta-amyloid protein (commercially available beta-amyloid 142). The luminophore may include at least one of Green fluorescent protein, Texas Red, Fluorescein, Coumarin, Indian Yellow, Luciferin, Rhodamine, Perylene, Phycobilin, Phycoerythrin, Umbelliferone, Stilbene, Alexa Fluor, Oregon Green, HiLyte Fluor, Th-T, DCVJ and quantum dots.

A centrifuge having a meniscus defining sample holder 100 and a fluorescence measurement system 1100 located at a fixed radial distance along the sedimentation region 110 of the sample channel 104 may be used to detect a species in the tagged sample. The centrifuge may be operated such that the sample placed in the sample loading region 108, flows into the sedimentation region 110 of the sample channel and any excess sample flows into the overflow channel 106. A fixed meniscus position 808 may be obtained near the overflow connection 112. As the centrifuge spins, the individual species within the sample including the tagged species may then begin moving away from the meniscus position 808. Luminescence (e.g., fluorescence, phosphorescence, chemi-luminescence) may be measured at the measurement position 1116 and a change in luminescence may be detected when the tagged species crosses the measurement position 1116. The velocity of the tagged species may be calculated based, at least in part, on the time taken for the species to travel from the meniscus position 808 to the measurement position 1116. The size, shape, molecular mass and concentration of the species may also be identified from the calculated velocity.

Such an implementation, may be useful in clinical diagnostics to diagnose neurodegenerative diseases including Alzheimer disease, Creutzfeldt-Jakob disease (CJD), bovine spongiform encephalopathy (BSE), Alexander disease, Alper's disease, Amyotrophic lateral sclerosis, Ataxia telangiectasia, Batten disease (also known as Spielmeyer-Vogt-Sjogren-Batten disease), Canavan disease, Cockayne syndrome, Corticobasal degeneration, Huntington disease, Kennedy's disease, Krabbe disease, Lewy body dementia, Machado-Joseph disease (Spinocerebellar ataxia type 3), Multiple sclerosis, Multiple System Atrophy, Parkinson disease, Pelizaeus-Merzbacher Disease, Pick's disease, Primary lateral sclerosis, Refsum's disease, Sandhoff disease, Schilder's disease, Spinocerebellar ataxia (multiple types with varying characteristics), Spinal muscular atrophy, Steele-Richardson-Olszewski disease, Tabes dorsalis.

### Detection of Antibodies and Antigens

In another implementation, an agent such as an antibody that is bound to a labeling agent such as a luminophore may be added to the sample to form a tagged sample. In such an implementation, the agent-luminophore combination may bind itself to a species in the sample. During operation of the centrifuge, the velocity (or sedimentation coefficient) of the species may be identified from the measuring the time taken to travel from the meniscus position 808 to the measurement position 1116 where the agent-luminophore combination bound to the species can be detected by the fluorescence measurement system 1100.

A similar implementation involves the addition of an agent (peptide, nucleotide, saccharide, lipid) labeled with a luminophore. The agent is or mimics an antigen that can bind to an unlabeled antibody. Such an implementation may be used to detect antibodies that are produced as part of a disease state or to demonstrate the lack of antibodies which is diagnostic of other disease states.

The implementations described herein may be used to detect antigens in a sample that provoke an immune response such as infectious agents, allergens, auto-antibodies. Antigens may include bacteria, viruses, protozoa and ameba. The agent may include an antibody that preferentially binds to a particular antigen. The invention may be used in clinical diagnostics to diagnose at least H.I.V., Hepatitis A, B and C, and Rheumatoid Arthritis. In one implementation, the invention may be used to diagnose cancer.

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

What is claimed is:

1. A sample holder for a centrifuge, comprising
a substrate, having
sample channel formed within the substrate including a sample loading region and a sedimentation region, and
an overflow channel formed within the substrate and connected to the sedimentation region of the sample channel,
wherein a portion of the overflow channel intersects the sedimentation region to form a fluid connection and thereby define a meniscus position.

2. The sample holder of claim 1, wherein the substrate has a detachable connection with a rotor of the centrifuge.

3. The sample holder of claim 2, wherein the rotor has a chamber and the substrate removably fits into the chamber.

4. The sample holder of claim 1, wherein the substrate is formed in the shape of a rotor of the centrifuge.

5. The sample holder of claim 1, wherein the substrate has a detachable connection with a spindle of the centrifuge.

6. The sample holder of claim 1, wherein the substrate comprises at least one sample channel and at least one overflow channel formed onto a surface of the substrate.

7. The sample holder of claim 1, wherein the overflow channel intersects the sample loading region of the sample channel to form a fluid connection and thereby equilibrate pressure in the overflow channel.

8. The sample holder of claim 1, wherein the overflow channel intersects an opening in the substrate to form a fluid connection and thereby equilibrate pressure in the overflow channel.

9. The sample holder of claim 1, wherein the sample channel is formed along a radial axis from a center of an axis of rotation of the centrifuge.

10. The sample holder of claim 9, wherein a portion of the overflow channel is formed along an axis at an angle away from the radial axis.

11. The sample holder of claim 1, wherein the angle between a portion of the overflow channel and the sedimentation region is an acute angle.

12. The sample holder of claim 1, comprising a window covering at least one wall of at least one of the sample channel and the overflow channel.

13. The sample holder of claim 12, wherein the window is hermetically sealed to at least one of the sample channel and the overflow channel.

14. The sample holder of claim 12, wherein the window comprises an optically inert plastic material.

15. The sample holder of claim 12, wherein the window includes at least one of quartz, sapphire and glass.

16. The sample holder of claim 12, comprising a material responsive to a sample.

17. The sample holder of claim 1, comprising a plurality of substrates.

18. The sample holder of claim 1, wherein the substrate is formed from a disposable material.

19. The sample holder of claim 18, wherein the disposable material is selected from the group consisting of epoxy, poly-di-methyl-siloxane (PDMS), polyisoprene, polybutadiene, polychloroprene, polyisobutylene, poly(styrene-butadiene-styrene), polyurethane, silicon, poly(bis(fluoroalkoxy)phosphazene), poly(carboranesiloxanes), poly(acrylonitrile-butadiene), poly(1-butene), poly(chlorotrifluoroethylene-vinylidene fluoride) copolymers, poly(ethyl vinyl ether), poly(vinylidene fluoride), poly(vinylidene fluoride-hexafluoropropylene) copolymer, polyvinylchloride (PVC), polysulfone, polycarbonate, polymethylmethacrylate (PMMA), polytetrafluoroethylene (Teflon), Phenolic Resin and Delrin.

20. The sample holder of claim 1, wherein the substrate includes materials capable of withstanding centrifugation forces greater than 300,000 g.

21. The sample holder of claim 1, comprising an identification panel on the substrate to distinguish samples from each other.

22. The sample holder of claim 21, wherein the identification panel includes a bar code label.

23. The sample holder of claim 1, comprising a sensor chip located near the sample channel.

24. The sample holder of claim 1, wherein the sedimentation region has a capacity of about 10 μL.

25. The sample holder of claim 1, wherein the overflow channel has a capacity of about ½ μL.

26. The sample holder of claim 1, wherein the sample loading region has a larger capacity than the sedimentation region.

27. The sample holder of claim 6, wherein a depth of the sample channel is about 1 mm.

28. The sample holder of claim 6, wherein a depth of the overflow channel is about 300 μm.

29. The sample holder of claim 1, wherein the substrate has a plurality of sample channels and overflow channels.

30. The sample holder of claim 1, wherein a width of the sample channel increases with radial distance from a center of an axis of rotation of the centrifuge.

31. The sample holder of claim 1, wherein a width of the overflow channel increases with radial distance from a center of an axis of rotation of the centrifuge.

32. A method of transferring a sample in a centrifuge, including the steps of
providing a sample holder for a centrifuge, comprising
a substrate, having
a sample channel formed within the substrate including a sample loading region and a sedimentation region, and
an overflow channel formed within the substrate and connected to the sedimentation region of the sample channel;
positioning the sample holder in the centrifuge with at least one sample channel substantially oriented along a radial direction from a rotating axis of the centrifuge;
operating the centrifuge such that a portion of the sample moves from the sample loading region to the sedimentation region; and
transferring an excess portion of the sample from the sedimentation region of the sample channel to the overflow channel such that a meniscus of the sample is maintained at a substantially constant position in the sedimentation region near the location of connection between the overflow channel and the sedimentation region.

33. The method of claim 32, wherein the sample loading region is closer to the center of the rotating axis than the sedimentation region to allow for samples to move from the sample loading region to the sedimentation region during the operation of the centrifuge.

34. The method of claim 32, comprising the step of attaching a window covering at least one wall of at least one of the sample channel and the overflow channel.

35. The method of claim 34, wherein the step of attaching a window includes hermetically sealing it to at least one of the sample channel and the overflow channel.

36. The method of claim 32, comprising the step of adding a sample using a pipette.

37. The method of claim 32, wherein the sample includes at least one of a liquid, gas, nucleic acid, protein, blood, saccharide and lipid.

38. A centrifuge, comprising
a rotor; and
a sample holder, including
a substrate, having
a sample channel formed within the substrate including a sample loading region and a sedimentation region, and
an overflow channel formed within the substrate and connected to the sedimentation region of the sample channel;
wherein the sample holder is detachably connected to the rotor.

39. A centrifuge of claim 38, comprising a plurality of sample holders.

40. A centrifuge of claim 38, wherein the rotor has a chamber and the sample holder removably fits into the chamber.

41. A centrifuge of claim 38, wherein the rotor is formed from titanium.

42. A centrifuge of claim 38, wherein the rotor is formed from epoxy composite.

43. A centrifuge of claim 38, wherein the rotor is formed from a material capable of withstanding centrifugation forces greater than 400,000 g.

44. A centrifuge, comprising
a rotor;
a sleeve detachably connected to the rotor; and
a sample holder, including
a substrate, having
a sample channel formed within the substrate including a sample loading region and a sedimentation region, and
an overflow channel formed within the substrate and connected to the sedimentation region of the sample channel;
wherein the sample holder is detachably connected to the sleeve.

45. A centrifuge of claim 44, wherein the sleeve is formed from titanium.

46. A centrifuge, comprising
a rotor, including
a substrate, having
a sample channel formed within the substrate including a sample loading region and a sedimentation region, and
an overflow channel formed within the substrate and connected to the sedimentation region of the sample channel.

47. The centrifuge of claim 46, wherein the rotor has a detachable connection with the spindle of the centrifuge.

48. A method of detecting a species in a sample, comprising
adding a luminophore to the sample to form a tagged sample such that the luminophore attaches to a species in the sample;
providing a sample holder for a centrifuge, comprising
a substrate, having
a sample channel formed within the substrate including a sample loading region and a sedimentation region, and
an overflow channel formed within the substrate and connected to the sedimentation region of the sample channel;
adding the tagged sample to the sample holder;
operating the centrifuge with the sample holder such that a meniscus of the tagged sample is maintained at a substantially constant position near the location of connection between the sample channel and the overflow channel;
measuring luminescence from the tagged sample at a position on the sample channel; and
detecting a species in a sample attached to the luminophore based on the time taken to travel from the substantially constant meniscus position to the measurement position.

49. The method of claim 48, wherein the luminescence is measured at a position on the sample channel along the radial direction from the rotating axis of the centrifuge.

50. The method of claim 48, wherein detecting the species includes calculating a velocity of the species based at least on the travel time, the meniscus position, the luminescence measurement position and an angular velocity of the centrifuge.

51. The method of claim 50, wherein the calculated velocity is used to determine a molecular mass of the species.

52. The method of claim 50, wherein a concentration of the species is determined as a function of the calculated velocity.

53. The method of claim 48, wherein the sample includes at least one of blood, protein, cerebral spinal fluid, nucleic acid, urine, sputum, saccharide and lipid.

54. The method of claim 48, wherein the species includes beta-amyloid protein.

55. The method of claim 48, wherein the luminophore includes at least one of Green fluorescent protein, Texas Red, Fluorescein, Coumarin, Indian Yellow, Luciferin, Rhodamine, Perylene, Phycobilin, Phycoerythrin, Umbelliferone, Stilbene, Alexa Fluor, Oregon Green, HiLyte Fluor, Th-T, DCVJ and quantum dots.

56. A method of detecting a species in a sample, comprising
adding an agent, bound to a luminophore, to the sample to form a tagged sample such that the agent binds to a species in the sample;
providing a sample holder for a centrifuge, comprising
a substrate, having
a sample channel formed within the substrate including a sample loading region and a sedimentation region, and
an overflow channel formed within the substrate and connected to the sedimentation region of the sample channel
adding the tagged sample to the sample holder;
operating the centrifuge with the sample holder such that a meniscus of the tagged sample is maintained at a substantially constant position near the location of connection between the sample channel and the overflow channel
measuring luminescence from the tagged sample at a position on the sample channel; and
detecting a species in a sample attached to the agent based on the time taken to travel from the substantially constant meniscus position to the measurement position.

57. The method of claim 56, wherein luminescence is measured at a position on the sample channel along the radial direction from the rotating axis of the centrifuge.

58. The method of claim 56, wherein detecting the species includes calculating a velocity of the species based on the travel time, the meniscus position, the luminescence measurement position and an angular velocity of the centrifuge.

59. The method of claim 58, wherein the calculated velocity is used to determine a molecular mass of the species.

60. The method of claim 58, wherein the calculated velocity is used to determine a concentration of the species.

61. The method of claim 56, wherein the sample includes at least one of blood, protein, cerebral spinal fluid, nucleic acid, urine, sputum, saccharide and lipid.

62. The method of claim 56, wherein the species includes at least one of a virus, a bacterium, a protozoan, an ameba and protein.

63. The method of claim 56, wherein the agent includes at least one of a protein and a nucleic acid.

64. The method of claim 56, wherein the luminophore includes at least one of Green fluorescent protein, Texas Red, Fluorescein, Coumarin, Indian Yellow, Luciferin, Rhodamine, Perylene, Phycobilin, Phycoerythrin, Umbelliferone, Stilbene, Alexa Fluor, Oregon Green, HiLyte Fluor, Th-T, DCVJ and quantum dots.

65. A method of detecting a species in a sample
adding a luminophore to the sample to form a tagged sample such that the luminophore attaches to a species in the sample;
providing a sample holder for a centrifuge, comprising
a substrate, having
a sample channel formed within the substrate including a sample loading region and a sedimentation region, and
adding the tagged sample to the sample holder;
operating the centrifuge with the sample holder;
measuring luminescence from the tagged sample at two or more positions on the sample channel; and
detecting a species in a sample attached to the luminophore based on the time taken to travel from one measurement position to another measurement position.

66. The sample holder of claim 1, comprising a sensor chip integrally formed in the sample channel.
